(19) United States
(12) Patent Application Publication
(10) Pub. No.: US 2007/0188818 A1
(43) Pub. Date: Aug. 16, 2007

(54) Tiltable document imaging apparatus

(75) Inventors: Robert M. Westcott, Holley, NY (US); Scott P. Haude, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/352,705

(22) Filed: Feb. 13, 2006

(51) Int. Cl. H04N 1/23

(52) U.S. Cl. 358/296

(57) ABSTRACT

A document imaging apparatus (10) for recording document data has an imager body (12) that has an image data transformation apparatus (34) and a paper feed apparatus (36) for urging a document sheet along a paper path from a paper feed input source (14), past the image data transformation apparatus (34), to an output slot (16). The imager body (12) is pivotably coupled to a support pedestal (20) for adjusting the tilt angle of the imager body (12) to one of a plurality of tilt angle positions.

### FIELD OF THE INVENTION

This invention generally relates to imaging apparatus for documents and more particularly relates to an imaging apparatus having a tiltable paper path.

### BACKGROUND OF THE INVENTION

Providers of desktop and portable computer equipment and peripherals are keenly aware of the value of reducing the desktop space requirements of these devices. In particular, there are benefits to reducing the dimensional footprint for a peripheral document imaging apparatus such as a printer or scanner, particularly since such a device may be used intermittently in many environments.

The optical scanner for scanning and recording documents is one well-known type of imaging apparatus. An optical scanner typically includes a scanning station having an optical reading element, a light source, and a platen formed from glass or transparent plastic for maintaining the scanned portion of the document in a flat position. In operation, optical data from the document is transmitted from the optical reading element to one or to several buffer memories that temporarily store the data for further processing, typically with compression of the scan data. The optical scanner thus transforms text and image markings that have been recorded on the scanned document to image data, providing the image data as its output.

By comparison with an optical scanner, a printing apparatus operates in the complementary direction, transforming image data at its input to printed text and image markings that are recorded onto the sheet substrate to form the document. A variety of types of portable printers are used in desktop and workgroup printing environments, for imaging by forming a document onto a substrate. Portable printers in this general class include, for example, ink jet printers, laser printers, and thermal printers, along with other types of printers that could be used.

For conventional desktop-based document imaging applications, whether for scanning a document or for printing a document, relative movement is provided in some way between the document substrate, such as paper, and the image data transforming components that scan the substrate either for marking or for extracting an image. In one well-known type of imaging apparatus, the flatbed scanner, the document remains stationary on a transparent platen and an optical reading element, mounted on a movable carriage assembly on the other side of the platen, travels along the length of the platen to scan the document sheet. However, with most types of desktop and workgroup imaging apparatus, both printers and scanners alike, the alternative “sheet-fed” model applies.

Using sheet-fed design, the image data transformation apparatus is stationary and the document sheet is scanned past the image data transformation apparatus, either for image recording or for optical scanning. Sheet-fed operation has advantages for automated operation and compactness in many applications and is well suited to line-by-line image sensing by a linear array of optical sensors in a scanner, as well as to line-by-line marking by a linear or linearly actuated printhead. A sheet-fed imaging apparatus can be used to scan or print single sheet documents or to successively pull one sheet at a time from a stack of sheets for scanning or printing, making this device better suited for applications where volume is important.

Both desktop scanners and desktop printers operate in document imaging environments where space or footprint is at a premium. Proposed solutions for reducing the space requirements for typical document imaging devices include the following:
U.S. Patent Application No. 2004/0262397 (Khovaylo) describes a flat-bed scanner that attaches to a support stand, allowing it to perform a single scan when inclined at angles from horizontal to vertical;
U.S. Pat. No. 6,233,064 (Griffin) describes a flatbed scanner capable of being placed for operation in a vertical position; and
U.S. Pat. No. 5,903,364 (Shih-Min) describes a scanner having a base plate with inclined surfaces that support the scanner unit in one of a number of different positions.

As one example, a reduced-footprint sheet-fed scanner, the DR-2050C scanner from Canon Electronics Inc., Saitama, Japan, has been introduced for desktop environments. In this device, the paper travel path is generally vertical, unlike conventional types of sheet-fed scanners. This vertical orientation may be acceptable for single-sheet scanning and for front-loading. However, the vertical paper path orientation is inherently disadvantaged for sheet feeding from a stack of sheets, particularly if the stack has sheets of varying thickness, for longer length sheets, where there are creases or inherent curl to the sheets, or where the paper stock for one or more sheets is relatively thin. Documents can tip over or even fall out of the feed tray when vertically oriented. Where sheets exit a paper handling mechanism at a steep vertical angle, there is tendency to curl. This tendency may not pose a problem when scanning a single sheet, but is increasingly cumbersome where a stack of sheets must be scanned, causing exiting sheets to jam together and to be out of order or skewed, often requiring manual resorting or other operator intervention. The use of an output tray is not optimal with paper exit at a steep angle. This same principle also applies for document printing. For applications in which only a single document is printed, a vertical paper path might easily be acceptable, particularly where the operator is standing by to obtain the printed document. However, where multiple sheet documents are printed or for applications where document output order is important, the vertical paper path is not desirable; instead, a paper path oriented toward horizontal is much preferred for printing multiple pages.

Thus, there are good reasons why, in conventional practice, sheet-fed document imaging systems maintain the stack of paper at an angle close to horizontal: paper handling works most smoothly where the stack of sheets lie atop each other at such an inclination. By contrast, paper path orientation at or close to vertical makes the task of paper handling considerably more complex and trouble-prone when scanning more than one sheet or longer sheets.

The demands on the paper handling components are heightened with the pressure to improve desktop scanner and printer performance and provide faster document processing speeds. As one illustration of this trend, efforts are underway to provide workgroup scanners with faster paper handling, using solutions that had been previously applied for higher volume production scanners. For example, where conventional workgroup scanners perform gray-scale scanning in the range of about 20 pages per minute (PPM) on average, it is conceivable that improvements in paper handling and in scanning optics will allow this speed to increase more than two-fold. In order to make this happen, however, the paper handling must be robust, providing output stacking in order, minimizing curl, jams, or other problems.

While footprint and capability for robust paper handling are important, ergonomic factors can also be considered. Where an operator performs a single-page scan or prints a single document, the more natural position is facing the imaging apparatus, with a vertical orientation being quite satisfactory. With the scan or print job taking a few seconds at most, the operator can wait to retrieve a single exiting document. However, where a stack of multiple pages is to be scanned or printed, feeding of the stack from the opposite or rear side of the scanner is more natural, particularly where document sheets may have different sizes or thicknesses. For example, an operator may load a set of documents for scanning, then be otherwise occupied during at least part of the scan, unwilling to stand by to resort individual documents that get out of order due to high exit feed angles. Or, a multi-page print job can be initiated over a network, where sheets feed automatically and where providing printed documents that are stacked in order is preferable.

With recent developments in banking and communications and ever increasing numbers of electronic transactions, it seems clear that desktop document imagers for departmental, workgroup, and consumer market segments will become increasingly more important, with impetus for improved overall performance, including increased speeds and more reliable paper handling. At the same time, desktop workspace remains at a premium in many work environments. There is thus a need for a flexible document imager solution that allows improved performance while minimizing device footprint.

### SUMMARY OF THE INVENTION

Briefly, according to one aspect of the present invention, a document imaging apparatus comprising an imager body that houses:
a) an image data transformation apparatus for recording document data;
b) a paper feed apparatus for urging a document sheet along a paper path from a paper feed input source, past the image data transformation apparatus, to an output slot; and
wherein the imager body is pivotably coupled to a support pedestal for adjusting the tilt angle of the imager body to one of a plurality of tilt angle positions.

It is a feature of the present invention that the paper path tilt angle adjusts to a position selectable by an operator.

It is an advantage of the present invention that it allows adjustment of the tilt angle for single- or multiple-document feeding while maintaining a small dimensional footprint.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a perspective view of the document imaging apparatus of the present invention in one embodiment;

FIG. 2 is a side view of the document imaging apparatus showing locations of internal components;

FIG. 3 is a side view of the document imaging apparatus tilted to a near-vertical position;

FIG. 4 is a side view of the document imaging apparatus tilted to an intermediate tilt position;

FIG. 5 is a side view of the document imaging apparatus tilted to a near-horizontal position;

FIG. 6 is a perspective view of the document imaging apparatus, from a stack loading position;

FIG. 7 is a side view of the document imaging apparatus, with the top tray folded down;

FIG. 8 is a perspective close-up view showing a locking tilt mechanism in one embodiment;

FIG. 9 is a perspective view showing a latch mechanism in an alternate embodiment; and

FIG. 10 is a block diagram showing overall functions of a document imaging apparatus according to the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The term “document imaging apparatus” as used herein refers to the large class of devices that are either used for recording document data in either of two directions: (i) recording images and other types of human-readable information onto a sheet of substrate to form a document according to image data, or (ii) obtaining and recording machine-readable image data from a document sheet by optical scanning. Devices for recording human-readable information onto a document sheet include various types of printer apparatus, such as inkjet, thermal, photographic, laser, and line printers, for example. Devices for obtaining and recording machine-readable image data are generally classified as scanners.

It is instructive to note that there are a number of devices that may use a scanner, as the term is used with respect to the present invention. The term scanner generally applies to a device that optically scans a document to obtain and record machine-readable image data signals representative of the content of the document. The term scanner thus comprises not only the various types of flat platen and paper feed desktop scanners described in the Background section given earlier, but also comprises applicable portions of facsimile apparatus, commonly called fax machines, copier apparatus, and other similar devices, including devices that combine these image capture, reproduction, and transmission functions. Numerous types of sheet documents can be scanned, including items such as text documents and forms, banking and legal transaction documents, applications, photographs and other images, artwork, and identification documents such as credit cards, driver's licenses, ID badges, and the like. Similarly, while the present invention applies to a printer, it also applies to a device that includes a printing or marking apparatus as a component, such as facsimile apparatus, for example.

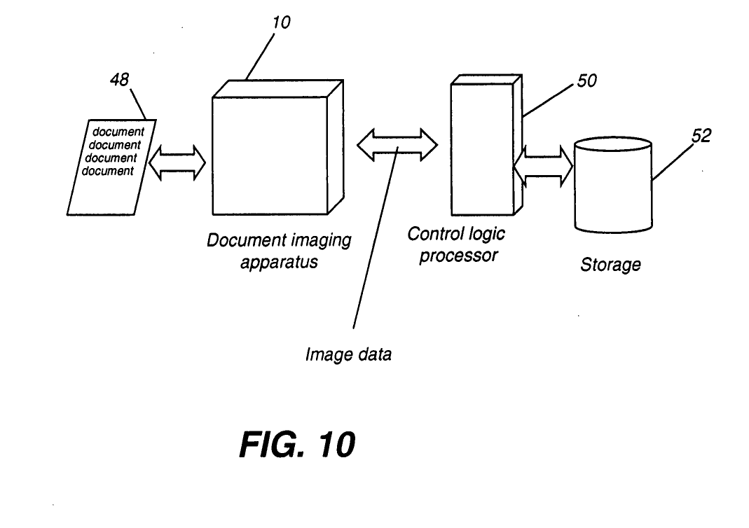

As is shown in the block diagram of FIG. 10, a lower-cost desktop or workgroup document imaging apparatus 10 such as a printer or scanner is typically connected to a control logic processor 50 such as a computer workstation of some type and may be used in any of a number of different environments. Control logic processor 50 typically has supporting image data storage 52 for reading or writing the image data that is being recorded to or from a document 48 by document imaging apparatus 10. In some environments, for example, an operator uses a workgroup scanner to scan a single sheet document, such as an identification document. Alternately, an operator may periodically print a single page form or other type of “on-demand” document. As was noted earlier in the Background section, front feeding with the operator standing by is typical for this type of scanning or printing. A vertical paper path orientation would be quite suitable for a sheet-fed document imaging apparatus in this type of application. At the other end of the spectrum, a workgroup scanner could be used to scan documents that are fed from a stack, such as in an environment where bank checks or multi-page forms are scanned. Similarly, a printing apparatus could be configured to serve multiple users on a network. For such applications, because of the paper handling considerations described earlier, a paper path inclined more closely toward the horizontal would be much preferred. It can be appreciated that there would be particular advantages to a scanner or printer design that could serve both single-feed and stack-feed environments, adapting readily to the document imaging job at hand, easily adjusted into position by the operator, and requiring only a minimal footprint at the same time.

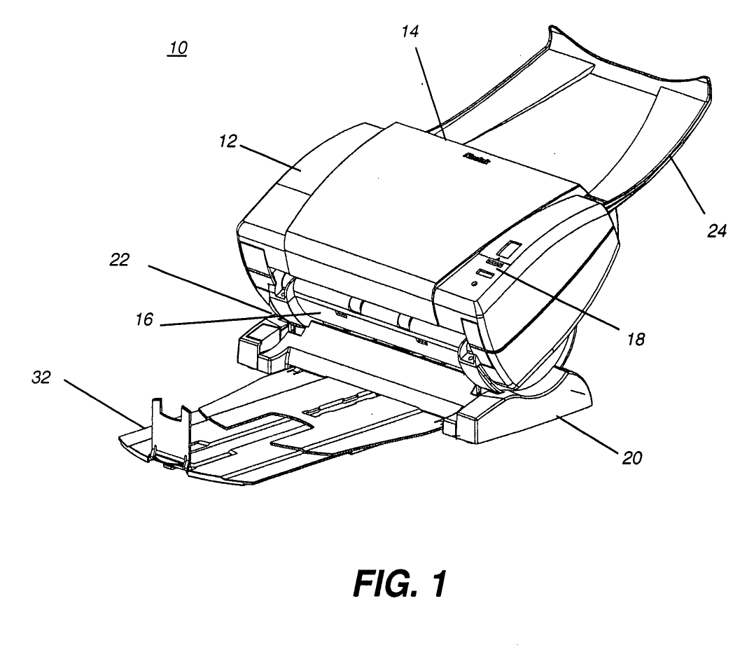

Referring to the perspective view of FIG. 1, there is shown document imaging apparatus 10 according to one embodiment of the present invention. An imager body 12 houses the paper feed mechanism and one or more image data transformation components for recording document data in a scanned manner, such as a printhead for recording an image according to image data or scanning camera optics and sensing components needed to obtain and record the scanned image data. Imager body 12 has a paper feed input source 14 and an output slot 16 for paper exit. A control panel 18 has the necessary operator controls typical for desktop or workgroup operation of document imaging apparatus 10, such as on-line/off-line controls, scanner or printer mode controls and selections, begin and cancel controls, and the like. Imager body 12 is mechanically coupled to a support base or pedestal 20 in a pivotal manner. A pivoting mechanism 22 provides a pivotal coupling that allows the tilt angle of imager body 12 to be optimally adjusted for various types of use. An optional output tray 32 may be provided, fitted either into imager body 12 or support pedestal 20, as described subsequently. An input tray 24 folds upward to support input document sheets where necessary; input tray 24 can also be folded down against imager body 12, particularly where only single-sheet feeding is needed.

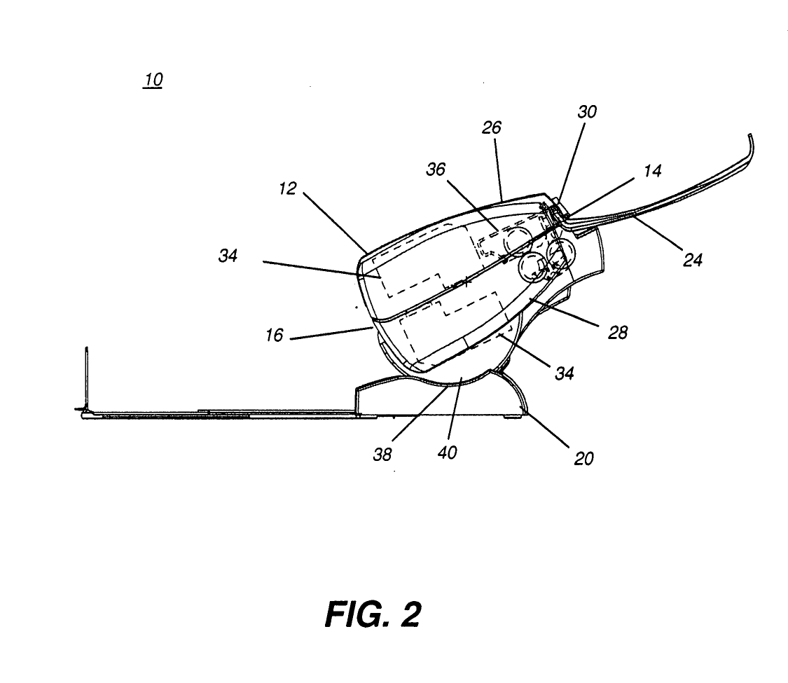

The arrangement of imager body 12 pivotably coupled to support pedestal 20 is particularly advantaged for allowing easy access to internal document imaging apparatus components along the paper path. The side view of FIG. 2 shows one embodiment in which imager body 12 has a first section 26 and a second section 28, which may be hinged together near output slot 16 and having a detachable latch 30 of some type, such as near paper feed input source 14. In the particular embodiment shown in FIG. 2, imager body 12 acts as a scanner, providing duplex scanning. A first image data transformation apparatus 34 is a scanning camera assembly for scanning one side of a document to record document image data therefrom. A second image data transformation apparatus 34 is a scanning camera assembly for scanning the opposite side of a document. When configured for scanning, image data transformation apparatus 34 can use a CCD camera component or a CMOS sensing component, for example.

In terms of information flow, image data transformation apparatus 34 may operate in one of two directions to record document data, either to extract image data for recording from an image or to record an image from image data by printing or marking the document in some manner. For either printing or optical sensing embodiments, the document is moved at a controlled speed past image data transformation apparatus 34 where the transformation to or from image data occurs. In one alternate embodiment, where document imaging apparatus 10 is a printer, image data transformation apparatus 34 may be a marking module or element for recording an image, such as a printhead. Typically, only one printhead is used so that a single image data transformation apparatus 34 would be provided for a printer; however, a two-sided printing embodiment could employ first and second image data transformation apparatus 34 as printheads, as shown in FIG. 2.

A paper feed apparatus 36 provides single-sheet feeding for documents fed from paper feed input source 14. Paper feed apparatus 36 may urge document sheets for scanning along the paper path using a clutched feed drive, for example. With the hinged arrangement shown, these internal optical and paper feeding components, along with other components such as start-of-sheet/end-of-sheet sensors and auxiliary rollers for example, can be easily accessed for cleaning, clearing jams, or checking operation.

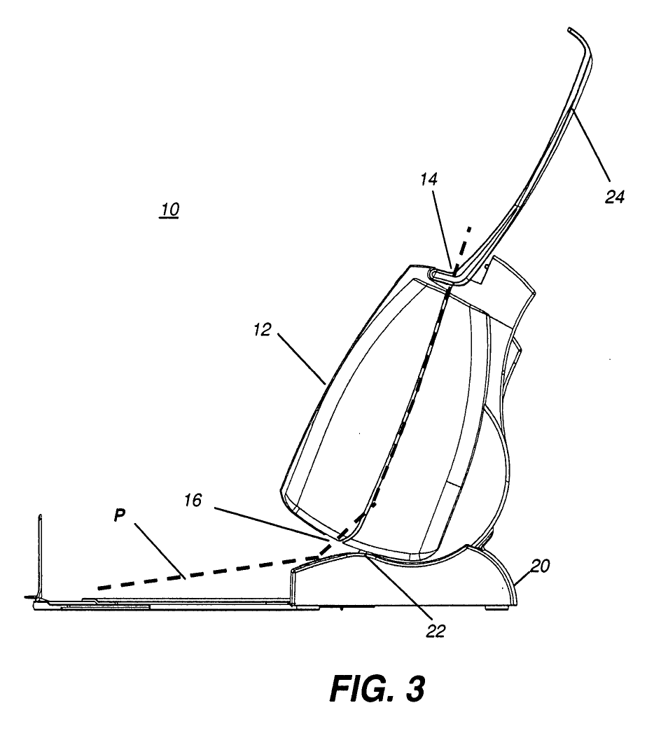

The side views of FIGS. 3, 4, and 5 show how the pivotal coupling provided by pivoting mechanism 22 allows document imaging apparatus 10 to be oriented in a suitable position for the type of imaging that is needed. A paper path is designated P and traced with a dashed line in these Figures. The term “paper path” has its standard connotation and defines the path the document sheet moves along within the document imaging apparatus 10, whether or not the document itself is paper, plastic, or some other non-paper material or hybrid material.

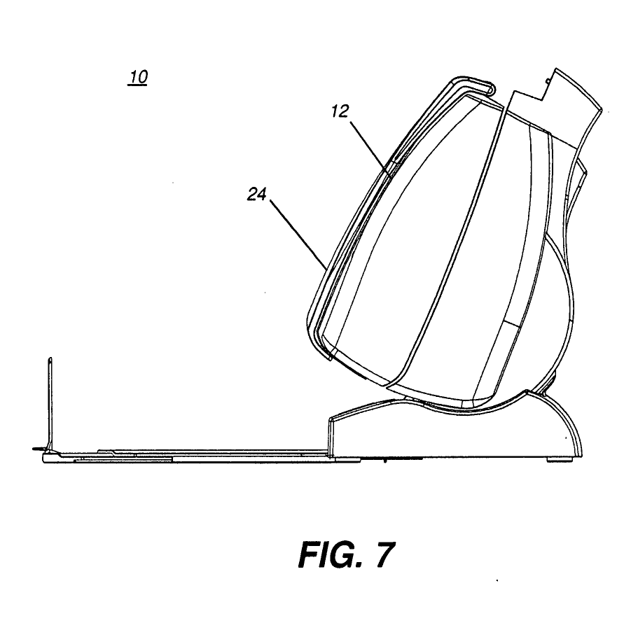

In FIG. 3, paper path P has a substantially vertical orientation within imager body 12. As noted earlier, this is often a preferred orientation for front-feeding when scanning or printing only one sheet. The sharp bend following output slot 16, as paper path P exits imager body 12 and veers to the horizontal, is a potential source of problems for smooth paper handling and can be more likely to cause curl with longer sheets or with folded sheets, for example. The FIG. 3 orientation advantageously provides the minimum footprint. For reduction of both footprint and height, hinged input tray 24 can be lowered against imager body 12, as shown in the side view of FIG. 7.

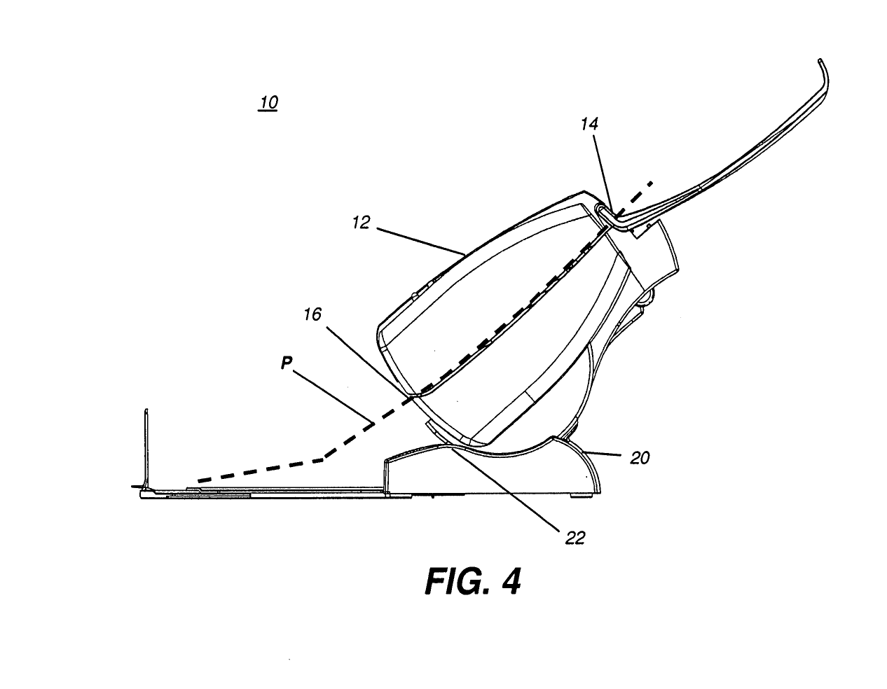

In the position shown in FIG. 4, paper path P has an orientation inclined more toward the horizontal. As noted earlier, this position is more favorable for sheet feeding from a stack of sheets, providing better sheet pick-up and separation at paper feed input source 14. This intermediate position also provides a reasonably smooth output portion of paper path P, so that proper stacking of scanned or printed sheets is more likely than with the FIG. 3 arrangement. The effective footprint with this orientation is larger than that shown in FIG. 3, but not quite as large as would be needed for a horizontally disposed unit.

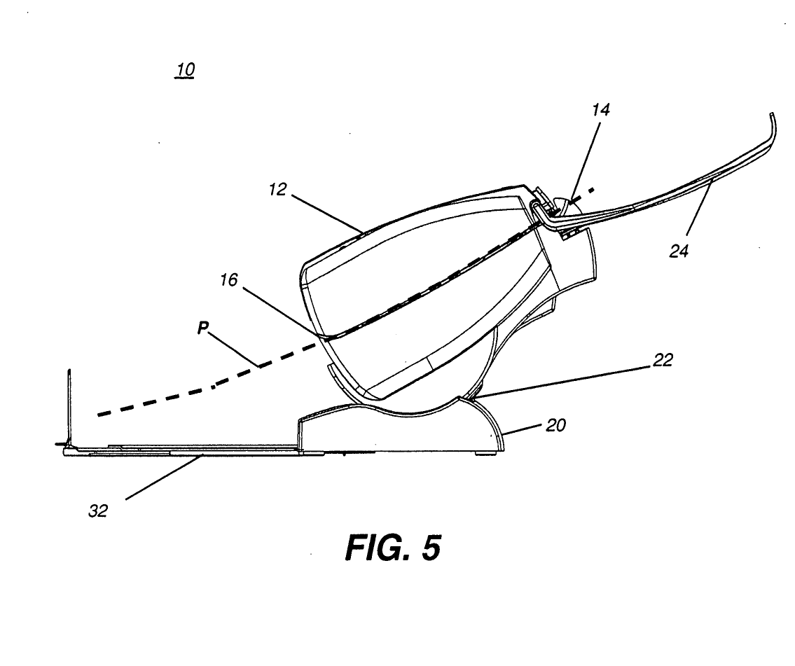

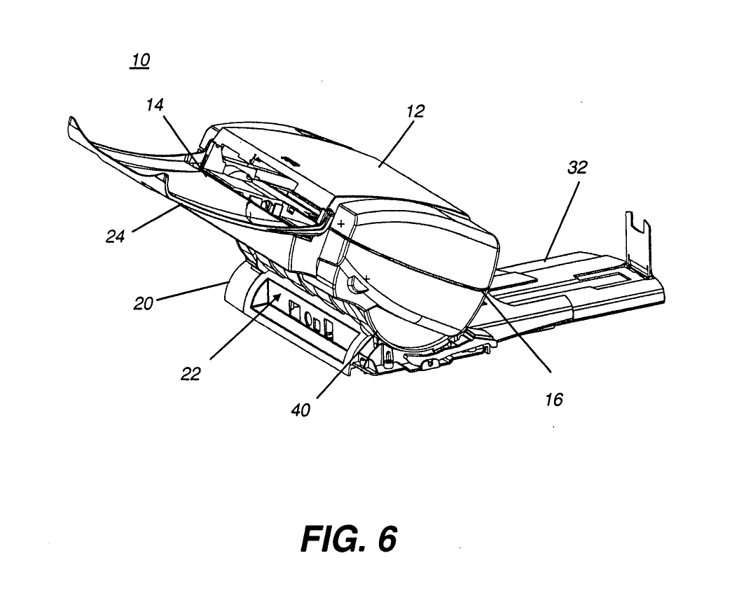

In the position of FIG. 5, paper path P is optimized for paper handling. At paper feed input source 14, separation and sheet pick-up work best. At output slot 16, paper path P inclines gently toward horizontal, providing the optimum stacking arrangement for many types of documents. Ergonomically, this is the optimal rear-feeding orientation for scanning. This is also typically the best arrangement for unattended printing, with a stack of unprinted media loaded in input tray 24. However, this arrangement is not optimized for footprint, particularly where input tray 24 and output tray 32 are extended as shown. FIG. 6 shows a perspective view of document imaging apparatus 10 from the rear-feeding position.

Output tray 32 can be positioned or seated in any of a number of positions. In one embodiment, output tray 32 can be fitted beneath support pedestal 20; this would be an advantageous arrangement at the near-vertical orientation of FIG. 3. Output tray 32 can also be fitted into support pedestal 20; this arrangement would be advantageous in the intermediate orientation of FIG. 4. Optionally, output tray 32 can be fitted into imager body 12; this would be a practical arrangement when using the near-horizontal orientation of FIG. 5.

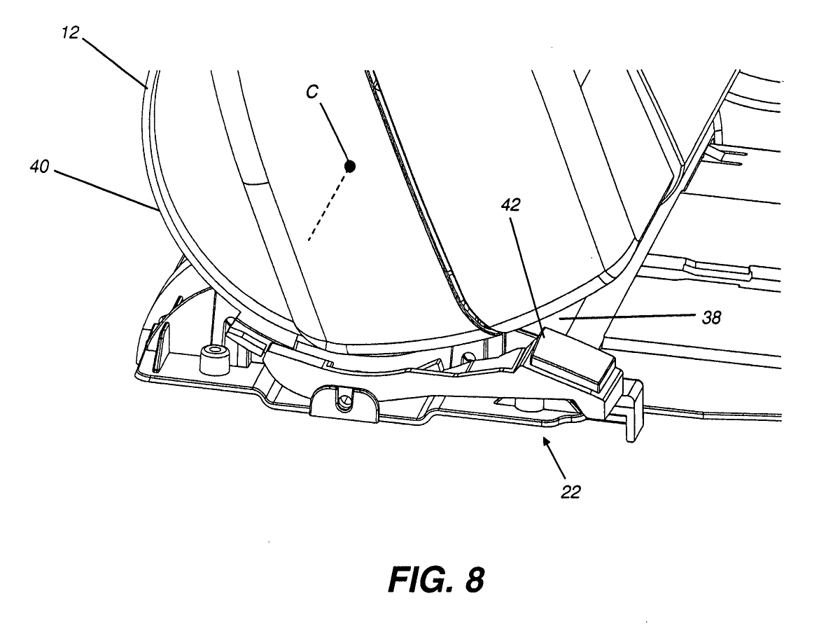

Pivoting mechanism 22 can take any of a number of forms. In the embodiment of FIGS. 1-7, pivoting mechanism 22 uses components from both imager body 12 and support pedestal 20. With reference to FIGS. 2 and 8, for example, a circular track 38 is provided in support pedestal 20. A mating circular flange 40 on imager body 12 seats within track 38 in an interlocking fashion that allows pivoting movement about a pivot point C. A latch mechanism 42 allows tilting of imager body 12 to one of a number of fixed positions, such as those shown in FIGS. 3-5. In one embodiment, fixed tilt positions of about 65, 52, and 25 degrees relative to horizontal are provided, roughly corresponding to the tilt positions shown in the examples of FIGS. 3, 4, and 5. Advantageously, latch mechanism 42 can be designed to lock imager body 12 into a tilt position, so that this position is maintained during scanning or printing or during cleaning or other access to internal parts, as shown in FIG. 2. Latch mechanism 42 shown in the embodiment of pivoting mechanism 22 of FIG. 8 has the advantage of maintaining a minimal footprint.

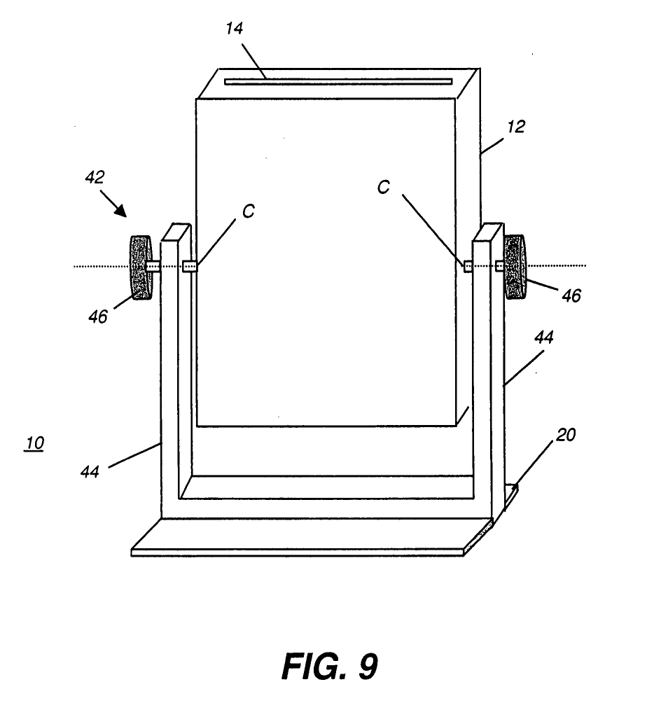

Possible alternatives to latch mechanism 42 include various types of tightening mechanisms that would allow continuous adjustment of tilt angle, rather than discrete, fixed-position adjustment. As one alternative, shown in the perspective view of FIG. 9, support pedestal 20 has arms 44 extending upwards to support pivot points C, with suitable adjustment knobs 46, based on a standard threaded-fastener model, that are loosened to tilt imager body 12 to an appropriate position, then tightened to hold this position. This type of latch mechanism 42 allows adjustment over a continuous range of angles. Such an arrangement, however, may not be as advantageous to the dimensional footprint of document imaging apparatus 10 as is the embodiment of FIGS. 1-8.

When imager body 12 is configured as a printer body, the apparatus and method of the present invention are compatible with printheads that form a line of the image at a time. When imager body 12 is configured as a scanner body, the apparatus and method of the present invention are compatible with scanning optics of various types, including components using CCD or CMOS sensors for high speed and lower cost or those using the more expensive and slower contact arrays.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, a variety of paper handling components could be used for urging the document sheet along paper path P as part of paper feed apparatus 36. Either single-side or duplex scanning or printing can be provided, as well as both printing and scanning functions, each provided using a separate image data transformation apparatus 34.

As noted earlier, document imaging apparatus 10 could be used to scan or print a full range of media types. Document sheets can be any of a number of types of materials, including paper, plastic, and hybrid combinations of paper and plastic, for example. Document sheet materials could be of various sizes and could be transparent, opaque, photosensitive, or have other suitable properties. Tilt angle adjustment of imager body 12 could be effected using any of a number of different types of pivoting mechanisms 22, including automated mechanisms that set or reset tilt position according to programmed instructions or to sensed conditions, such as document type, paper stack thickness, or timeouts, for example.

Thus, what is provided is a document imaging apparatus having a tiltable paper path.

### PARTS LIST

10 document imaging apparatus
12 imager body
14 paper feed input source
16 output slot
18 control panel
20 support pedestal
22 pivoting mechanism
24 input tray
26 section
28 section
30 latch
32 output tray
34 image data transformation apparatus
26 paper feed apparatus
38 track
40 flange
42 latch mechanism
44 arm
46 knob
48 document
50 control logic processor
52 image data storage

1. A document imaging apparatus comprising an imager body that houses:
a) an image data transformation apparatus for recording document data;
b) a paper feed apparatus for urging a document sheet along a paper path from a paper feed input source, past the image data transformation apparatus, to an output slot; and
wherein the imager body is pivotably coupled to a support pedestal for adjusting a tilt angle of the imager body to one of a plurality of tilt angle positions.

2. The document imaging apparatus according to claim 1 wherein the pivotal coupling is provided by a latch mechanism.

3. The document imaging apparatus according to claim 2 wherein the latch mechanism provides at least two fixed positions.

4. The document imaging apparatus according to claim 1 wherein the pivotal coupling allows continuous angular adjustment over a range of angles.

5. The document imaging apparatus according to claim 1 wherein the paper feed apparatus comprises a clutched feed drive.

6. The document imaging apparatus according to claim 1 further comprising an output tray for collecting document sheets that exit from the output slot.

7. The document imaging apparatus according to claim 6 wherein the output tray attaches to the imager body.

8. The document imaging apparatus according to claim 6 wherein the output tray attaches to the support pedestal.

9. The document imaging apparatus according to claim 1 wherein the image data transformation apparatus comprises a scanner.

10. The document imaging apparatus according to claim 9 wherein the image data transformation apparatus comprises a contact array.

11. The document imaging apparatus according to claim 9 wherein the image data transformation apparatus comprises a CCD sensor.

12. The document imaging apparatus according to claim 1 comprises a pivotal coupling having a tightening mechanism.

13. The document imaging apparatus according to claim 1 wherein the imager body further comprises an input tray that operates in any of at least two alternative positions.

14. The document imaging apparatus according to claim 9 wherein the image data transformation apparatus comprises a CMOS sensor.

15. The document imaging apparatus according to claim 1 wherein the image data transformation apparatus comprises a printhead.

16. The document imaging apparatus according to claim 15 wherein the printhead is an inkjet printhead.

17. The document imaging apparatus according to claim 15 wherein the printhead is a thermal printhead.

18. The document imaging apparatus according to claim 1 wherein the image data transformation apparatus comprises a laser.

19. The document imaging apparatus according to claim 1 wherein the document sheet is a photosensitive medium.

20. A document imaging apparatus comprising:
a) an imager body comprising an image data transformation apparatus for recording document data and a paper feed apparatus for urging a document sheet along a paper path from a paper feed input source, past the image data transformation apparatus, to an output slot;
b) a support base; and
c) a pivotal coupling for adjusting a tilt angle of the imager body to one of a plurality of tilt angle positions relative to the support base.

21. The document imaging apparatus according to claim 20 wherein the pivotal coupling comprises a circular flange on the imager body and a mating track on the support base.

22. The document imaging apparatus according to claim 20 wherein the pivotal coupling is continuously adjustable.

23. The document imaging apparatus according to claim 20 wherein the pivotal coupling adjusts to a plurality of predefined positions.

24. The document imaging apparatus according to claim 20 wherein the image data transformation apparatus comprises a CCD sensor.

25. The document imaging apparatus according to claim 20 wherein the image data transformation apparatus comprises a CMOS sensor.

26. The document imaging apparatus according to claim 20 wherein the image data transformation apparatus comprises an inkjet printhead.

27. The document imaging apparatus according to claim 20 wherein the image data transformation apparatus comprises a thermal printhead.

28. The document imaging apparatus according to claim 20 wherein the document sheet is a photosensitive medium.

29. A scanning apparatus comprising a scanner body that comprises at least one scanning camera and a paper feed apparatus for urging a document sheet along a paper path from a paper feed input source, past the at least one scanning camera, to an output slot; wherein the scanner body is pivotably coupled to a support pedestal for adjusting a tilt angle of the scanner body to one of a plurality of tilt angle positions.

30. A printing apparatus comprising a printer body that comprises at least one printhead and a paper feed apparatus for urging a document sheet along a paper path from a paper feed input source, past the at least one printhead, to an output slot; wherein the printer body is pivotably coupled to a support pedestal for adjusting a tilt angle of the printer body to one of a plurality of tilt angle positions.

31. A method for scanning a document comprising:
a) providing a scanner body comprising a scanning camera and a paper feed apparatus for urging a document sheet along a paper path from a paper feed input source, past the scanning camera, to an output slot; and
b) coupling the scanner body to a support pedestal using a pivotal coupling mechanism to permit adjustment of a tilt angle of the scanner body to one of a plurality of tilt angle positions.

32. A method for printing a document comprising:
a) providing a printer body comprising a printhead and a paper feed apparatus for urging a document sheet along a paper path from a paper feed input source, past the printhead, to an output slot; and
b) coupling the printer body to a support pedestal using a pivotal coupling mechanism to permit adjustment of a tilt angle of the printer body to one of a plurality of tilt angle positions.
